(19) United States
(12) Patent Application Publication
(10) Pub. No.: US 2008/0207110 A1
(43) Pub. Date: Aug. 28, 2008

(54) Rear axle breather

(75) Inventors: Jean-Luc Guichaoua, Combrit (FR); Benoit Le Roux, Fouesnant (FR); Gerard Malgorn, Quimper (FR); Jean-Yves Picard, Quimper (FR)

Correspondence Address: KRIEG DEVAULT LLP, ONE INDIANA SQUARE, SUITE 2800, INDIANAPOLIS, IN, 46204-2079, US

(73) Assignee: Cummins Filtration IP, Inc.

(21) Appl. No.: 12/070,649

(22) Filed: Feb. 20, 2008

(30) Foreign Application Priority Data
Feb. 22, 2007 (FR) 07 01262

(51) Int. Cl. F24F 7/04; B60H 1/24; F16H 57/04

(52) U.S. Cl. 454/237; 454/141; 74/606 A

(57) ABSTRACT

The purpose of the invention is a device to circulate air between the interior and the exterior of an enclosure (1) intended to contain air and a liquid, in which the enclosure (1) is an element intended to be installed in a vehicle, characterized in that it consists of at least two separate conduits (2, 3), connecting the interior of said enclosure (1) to its exterior, in which one conduit (2) is dedicated to the intake of air under normal conditions of pressure difference between the interior and the exterior of said enclosure (1), and one conduit (3) is dedicated to the release of air under normal conditions of pressure difference between the interior and the exterior of said enclosure.

This invention falls within the field of equipment that uses an enclosure containing a liquid, such as oil or fuel, in which the enclosure is, in particular but not exclusively, intended to be installed in a heavyweight type vehicle.

In the field of the invention, it is common to implement breather systems that circulate air within an enclosure containing a liquid, such as a rear axle assembly differential, transmission, fuel reservoir or even an engine cylinder head.

Traditionally, heavyweight transmission breathers consist of a conduit extending from the transmission to a distant (rear and/or upper) part of the vehicle. These conduits are installed to allow air to be exchanged freely between the interior and the exterior of the transmission.

However, such a solution requires that a bulky conduit be installed, and the fact that the conduit is relatively long is justified by the fact that, because intake occurs freely, water and/or impurities can get into the conduit, but it is unlikely that they will go the entire length of the conduit.

In addition, this solution does not prevent the emission of oil laden fumes, which is not desirable from an environmental standpoint.

Another breather technique has been proposed in prior art, in this case applied to the rear axle (differential) of a heavyweight vehicle.

In this technique, a primary conduit connects the interior and the exterior of the rear axle containing oil, and a membrane is placed in the conduit on the interior side of the axle, so as to prevent the spraying of oil and/or oil fumes inside the axle.

The function of this conduit is to allow the exchange of air under normal conditions of pressure difference between the interior and the exterior of the axle.

For abnormal situations of pressure difference between the interior and the exterior of the axle, a safety valve is installed that can open in the event of a significant decrease or increase in pressure inside the axle, the air flow then being redirected from the primary conduit to the safety valve.

Such a situation may occur in practice due to the implementation of the membrane on the primary conduit.

Indeed, as oil is deposited, a film forms on the membrane. In addition to this film, impurities (particularly brought in by the intake of air) stick to the membrane. Eventually, this results in sealing off the membrane, which prevents the circulation of air between the interior and the exterior of the axle. The breather then no longer functions, and phenomena related to significant increases or decreases in pressure may occur. To avoid such phenomena, the safety valve, under these conditions, performs its function of reconnecting the interior of the axle with the extension of said axle; however, it does so without the mechanism being protected from exterior contamination. In addition, when the safety valve opens, there is a risk that it will allow a puff of oily aerosol escape, which is of course to be avoided.

Currently, the sealing off cannot be detected. However, it is widely known that this sealing off can occur before the end of the vehicle's lifespan. It would therefore be prudent to equip the system with a sensor that indicates when the sealing off occurs. However, this would involve an additional equipment cost. Moreover, when the sealing off is detected, it would be necessary to replace the membrane, which would involve immobilizing the vehicle and maintenance costs.

The purpose of the invention is to resolve the disadvantages of prior art.

More specifically, the purpose of the invention is to propose a technique for connecting the interior and the exterior of an enclosure that might contain air and a liquid, that prevents the emission of fluid to the exterior, while eliminating or at the very least considerably reducing the risks of causing abnormal functioning conditions.

Another objective of the invention is to provide such a technique that preserves the quality of the fluid contained in the enclosure with respect to external impurities.

Another objective of the invention is to provide such a technique that can be adapted easily to existing enclosures, without significantly modifying them.

Another objective of the invention is to provide such a technique that has a simple design, is easy to implement, and is inexpensive to produce.

These objectives, as well as others that will become evident later, are reached with the invention, which involves a device to circulate air between the interior and the exterior of an enclosure that contains air and a liquid, said enclosure being an element intended to be installed in a vehicle, characterized in that it consists of at least two separate conduits connecting the interior and the exterior of said enclosure, in which one conduit is dedicated to the intake of air under normal conditions of pressure difference between the interior and the exterior of said enclosure, and one conduit is dedicated to the release of air under normal conditions of pressure difference between the interior and the exterior of said enclosure.

In this way, the flow of incoming air is clearly separate from the flow of outgoing air. It is thus possible to combine the means dedicated to each type of air flow in order to control the flow of undesirable materials (e.g. dust, water, oil, fuel) without it interfering with the proper functioning of the device, or in other words, with the incoming/outgoing flow of air under normal conditions. This separation of air flows makes it possible to optimally manage each type of air flow, without the performance of one of the flow types detracting from the performance of the other flow type.

The notion of “normal conditions” refers to functioning in which the device circulates air under the usual conditions of pressure difference between the interior and the exterior of the enclosure (in other words on the order of one tenth of a bar), as such a difference could be caused by air expansion phenomena in the enclosure as a function of temperature. This notion of “normal conditions” is therefore the opposite of abnormal conditions of pressure difference (for example greater than 0.3 bars) caused by undesirable phenomena indicative of a possible dysfunction (such as the sealing off of the oil retention membrane mentioned in reference to prior art).

Advantageously, the device includes a means of retaining said fluid inside the enclosure, said means of retention preferably being installed in said air release conduit.

In one advantageous solution, said means of retention includes a first membrane that obstructs said air release conduit on the interior side of said enclosure.

The retention methods make it possible to prevent, in widely known ways, any emission of oils or fuel, in liquid, vapor, or aerosol form.

Advantageously, the principle on which the invention is based makes it possible to prevent the flows of incoming air through the release conduit. As a result, no dust reaches the fluid retention membrane, thus avoiding the formation of a cake on the membrane, which can eventually lead to a sealing off of the membrane.

In one advantageous solution, the device includes a means of filtering the air that enters into said enclosure, and said means of filtration preferably include a second membrane that, at a minimum, obstructs said air intake conduit, from the exterior side of said enclosure.

In this way, no impurities enter the enclosure.

Moreover, due to the principle on which the invention is based, no outgoing flow of air, which might contain fluid, reaches this filtration membrane, which, as a result, is less subject to the sealing off phenomena caused by the dust/oil combination.

In one preferred solution, the device includes a safety conduit that is independent of said air intake and release conduits to compensate for an excessive pressure difference between the interior and the exterior of said enclosure.

One device as described in the invention is designed to reduce the risks of dysfunction, or even to eliminate said risks.

However, manufacturers' specifications require the implementation of safety systems that prevent situations of significant increases and decreases in pressure.

Such a characteristic thus makes it possible to meet the requirements of the manufacturers' specifications.

In this case, said security conduit preferably includes a bi-directional valve with wings that move under the effect of a predetermined pressure difference between the interior and the exterior of the enclosure.

A valve of this type becomes advantageous in terms of reduced bulk.

In another characteristic, said air intake conduit and/or said release conduit contain at least one calibrated unidirectional valve.

These valves may be calibrated, for example, to open in the event of a pressure difference on the order of 0.1 or even 0.2 bars. Therefore, of course, if such a pressure difference is not reached, the valves remain closed. The system thus allows a slight increase or decrease in pressure. In other words, the “breathing” is not continuous. On the contrary, it is limited by the calibration of the valves. Therefore, by limiting the breathing, we contribute to reducing the atmospheric contamination to which the mechanism is exposed.

In one preferred method of implementing the invention, said intake and release conduits are arranged as a single piece intended to be joined to said enclosure.

Such a single piece can easily be a piece made by casting or plastic injection for example, and can therefore incorporate the functions described in the invention, at a low cost.

Advantageously, the device includes a joint that creates an airtight seal between said piece and said enclosure, said piece having a groove to accommodate said joint.

Preferably, at least one of said conduits is positioned next to said groove, said joint forming a one-piece ensemble with said valve of said conduit.

A multipurpose joint is obtained, which decreases assembly operations and assembly time.

In addition, the position of the valve in question is predetermined by the joint, which avoids the risk of assembly error between the intake valve and the release valve.

Advantageously, said safety conduit is also positioned in said piece.

In this case, said safety conduit is preferably positioned near said groove, said groove forming a one-piece ensemble with said valve.

In this way, the assembly operations for the various systems of the piece are further simplified.

For certain vehicles and/or depending on demand from vehicle manufacturers, the device can be located away from the enclosure with which it is associated.

In various advantageous applications, said enclosure is the enclosure in:
a front or rear axle assembly differential of a vehicle;
a vehicle transmission;
a fuel or lubricant reservoir.

Other characteristics and advantages of the invention will become more clearly apparent by reading the following description of one preferred method of implementing the invention, given as an illustrative and non-limiting example, and the appended drawings, in which:

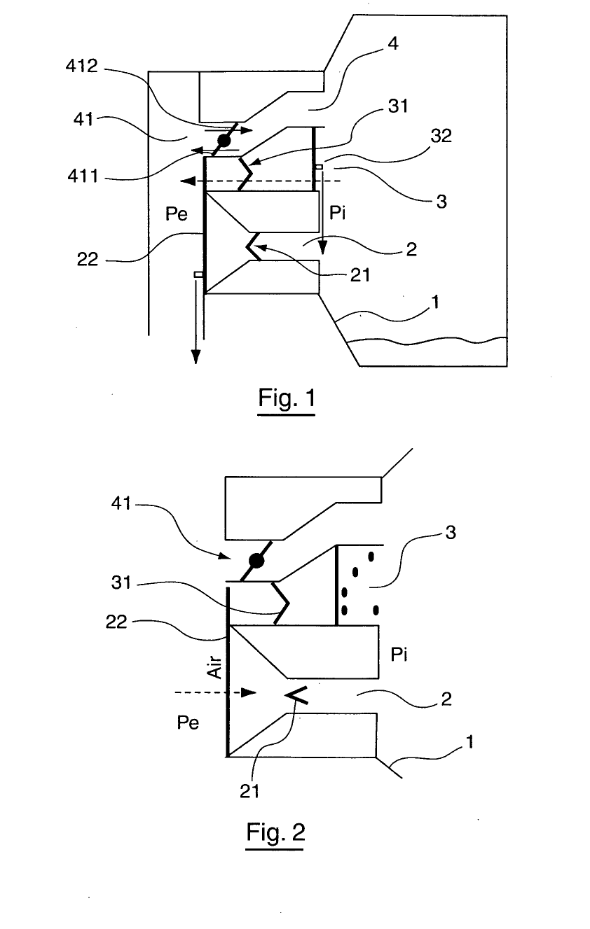

FIG. 1 is an illustration of the principle on which the invention is based;

FIG. 2 is an illustration of a device described in the invention, in a configuration of air intake under normal functioning conditions;

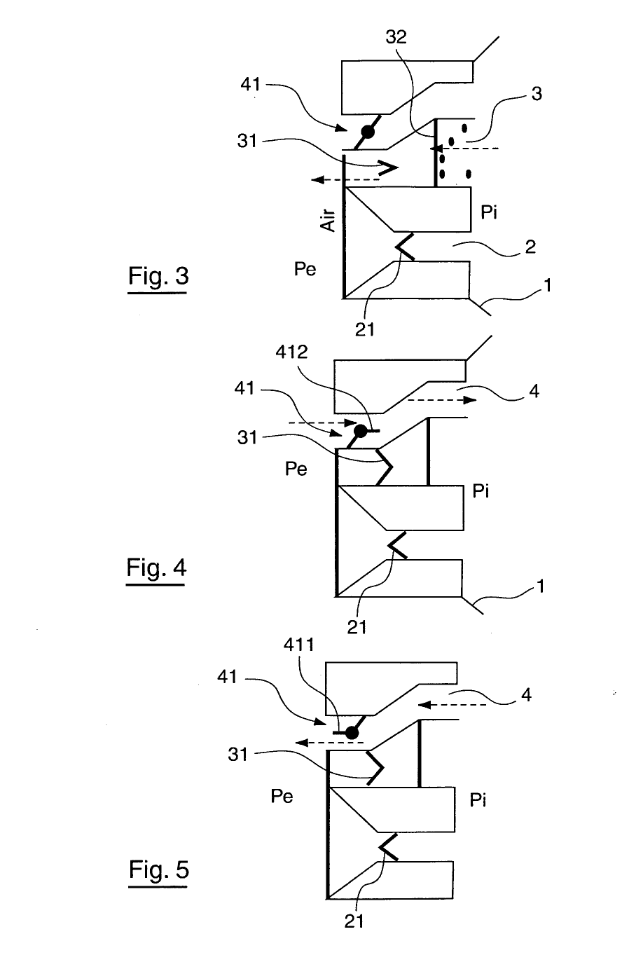

FIG. 3 is an illustration of a device described in the invention, in a configuration of air release under normal functioning conditions;

FIG. 4 is an illustration of a device described in the invention, in a configuration of air intake under safety functioning conditions;

FIG. 5 is an illustration of a device described in the invention, in a configuration of air release under safety functioning conditions;

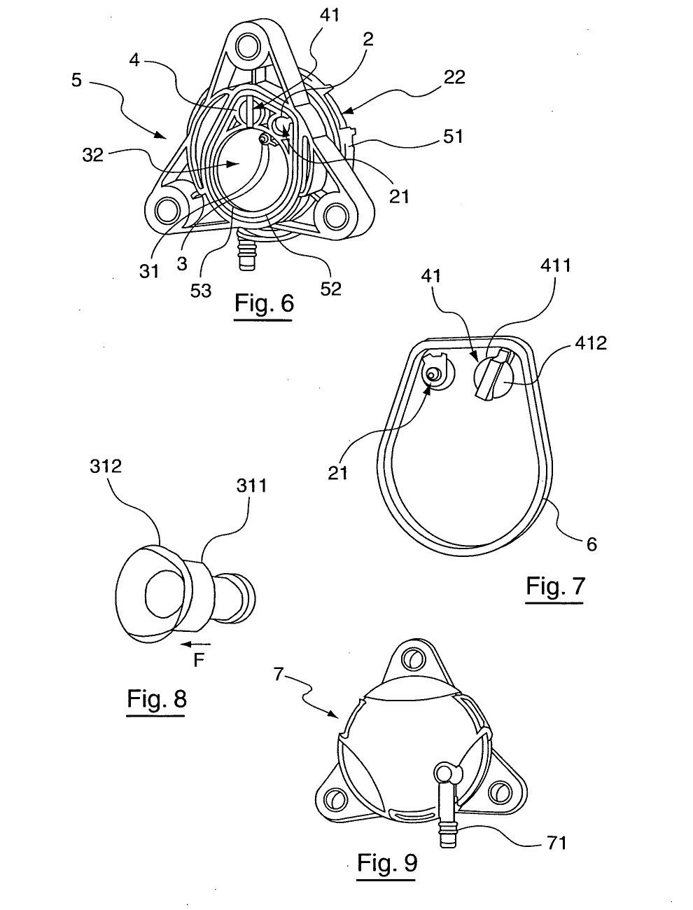

FIG. 6 is a perspective view of one particular method of implementing the invention;

FIG. 7 is a view of a specific joint, intended to be attached to the piece depicted in FIG. 6;

FIG. 8 is a view of a bendable valve intended to equip the piece depicted in FIG. 6;

FIG. 9 is a view of a lid intended to be associated with the piece depicted in FIG. 6.

As stated previously, the principle on which the invention is based lies in designing a device to circulate air between the interior and the exterior of an enclosure, in which the incoming and outgoing flows of air are separate.

This is illustrated in FIG. 1, which shows an enclosure (1) intended to contain a liquid and a volume of air, and the device described in the invention connected to such an enclosure consists of an air intake conduit (2) and an air release conduit (3) that can each connect the interior of the enclosure to the exterior of the enclosure.

In this method of implementation, the device also consists of a safety conduit (4) that can connect the interior of the enclosure with the exterior of the enclosure under conditions of predetermined (excessive) pressure difference between the exterior and the interior.

Conduit (2) includes a unidirectional valve (21) designed to allow only the intake of air (by being locked with respect to the release).

Inversely, conduit (3) includes a unidirectional valve (31) designed to allow only the release of air (by being locked with respect to the intake).

In addition, a fluid retention membrane (32) is installed in the release conduit (3) in order to catch the fluid vapors carried by the flow of outgoing air and/or fluid sprays, and the position of this membrane is preferably on the interior side of the enclosure.

An air filtration membrane (22) is also installed on the conduit (2) at the entry to it (or in other words on the exterior side of the enclosure).

In this method of implementation, the membrane (22) extends such that it also blocks the conduit (3) at its exit, on the exterior side of the enclosure.

Such a membrane is, for example, a non-woven synthetic multi-layer with a hydrophobic material or treatment on its external surface.

Valves (21) and (31) are of the type illustrated in FIG. 7.

As it appears in this figure, such a valve consists of a body (311) from which a bendable flange (312) extends. This flange (312) is shaped to flare out from the body (311) and can be bent under the effect of an air flow moving in the direction of the arrow (F) so as to allow such a flow to pass through.

Of course, the exterior diameter of the flange (312) is of a size such that, by default, the flange (312) forms a peripheral point of contact with the wall of the conduit in which it is installed. Thus, when the air flow is moving in the opposite direction of the arrow (F), the flange tends to be pressed more firmly against the wall of the conduit and thus prevents the air flow from passing through.

For the safety conduit (4), there is a bi-directional valve (41) which means that it can respond both to a pressure increase and to a pressure decrease inside the enclosure.

To this end, the valve (41) has two wings (411, 412) that move by bending elastically under the effect of an air flow. According to one principle that is similar to that of the valves described previously, one of the wings (411) bends under the pressure of an outgoing air flow, allowing the air to pass through, while the other wing (412) is pressed against the wall of the conduit (4). Inversely, the wing (412) bends under the push of incoming air, allowing the air to pass through while the other wing (411) is pressed against the wall of the conduit (4).

By default, the two wings are pressed against the wall of the conduit (4).

The functioning of a device as described in the invention is explained below in reference to FIGS. 2 to 5.

The functioning illustrated in FIG. 2 corresponds to a situation in which the exterior pressure (Pₑ) is greater than the internal pressure (Pᵢ) in the enclosure (1), with a difference between Pₑ and Pᵢ on the order of 0.1 bars or even 0.2 bars for example (which is equivalent to the usual pressure variations essentially caused by an expansion of the air inside the enclosure).

In this case, the pressure difference between Pₑ and Pᵢ tends to result in an incoming air flow, which causes the valve (21) to open (said valve is calibrated to bend at a predetermined pressure difference, in this instance 0.1 bars or even 0.2 bars), which allows air to enter the enclosure through the intake conduit (2).

The incoming air is filtered by the membrane (22).

However, valve (31) (installed inversely with respect to valve (21)) remains closed, and no air flow passes through the release conduit (3).

At the same time, valve (41) is closed (said valve being included to allow air to pass through for differences in pressure between Pᵢ and Pₑ that are greater than the usual pressure differences, for example for a difference of at least 0.3 bars (or more, as necessary).

The functioning illustrated in FIG. 3 corresponds to a situation in which the exterior pressure (Pₑ) is lower than the interior pressure (Pᵢ) inside the enclosure (1), with a difference between Pₑ and Pᵢ on the order of 0.1 bars or even 0.2 bars, for example.

In this case, the pressure difference between Pₑ and Pᵢ tends to result in a flow of outgoing air that causes valve (31) to open (said valve is also calibrated to bend at a predetermined pressure difference, in this instance 0.1 bars or even 0.2 bars), which allows air to exit the enclosure through the release conduit (3).

The outgoing air is filtered by the membrane (32), made of a synthetic, non-woven, multi-layer material that retains the fumes and/or fluid sprays.

However, valve (21) (installed inversely with respect to valve (31)) remains closed, and no air flows through the intake conduit (2).

At the same time, valve (41) is closed for the same reasons as in the case depicted in FIG. 2.

The functioning illustrated in FIG. 4 corresponds to a situation in which the exterior pressure (Pₑ) is lower than the interior pressure (Pᵢ) within the enclosure (1), with a pressure difference between Pᵢ and Pₑ that is greater than the usual pressure differences due to the expansion of the air in the enclosure. The valve is indeed calibrated to respond to a pressure difference of at least 0.3 bars (and up to 0.5 bars, for example). Such a pressure difference can arise due to the non-functioning (blockage) of valve (31) and/or a sealing off of the membrane (32) (although this blockage and/or sealing off is unlikely, as a result of the principle on which the invention is based).

In this case, the pressure difference tends to result in a flow of incoming air, which causes the wing (412) to open (said wing being calibrated so as not to bend until there is a pressure difference of 0.3 bars or even 0.5 bars), which allows air to enter the enclosure.

The functioning illustrated in FIG. 5 corresponds to a situation in which the exterior pressure (P₂) is greater than the internal pressure (Pᵢ) inside the enclosure (1), once again with a pressure difference between Pᵢ and Pₑ that is greater than the usual pressure differences due to the expansion of air inside the enclosure.

In this case, the pressure difference tends to result in a flow of outgoing air, which causes the wing (411) to open (said wing being calibrated so as not to bend until there is a pressure difference of 0.3 bars or even 0.5 bars), which allows air to exit the enclosure (valve (31) being in a situation that is considered blocked).

FIGS. 6, 7, and 9 depict a preferred method of implementing the invention.

As depicted in FIG. 6, the air intake (2) and air release (3) conduits, as well as the safety conduit (4) are positioned in a single piece (5) with a ring (51) intended to join with a lid (7) (FIG. 9) of a complementary shape, in order to attach this lid (7) to the ring (51).

The side of the piece (5) opposite the one with the ring (51) is intended to be placed facing a hole positioned in an enclosure and attached to said enclosure.

On this side, the piece (5) has a recess (53) with a circular cross-section that is intended to accommodate the fluid retention membrane (32), and the membrane extends across the entire surface of the recess (13).

In addition, this side of the piece (5) has a groove (52) that accommodates a joint that is intended to form an airtight seal between the piece (5) and the enclosure.

The groove (52) is positioned to skirt around the recess (53), the safety conduit (4) and the intake conduit (2). In particular, the path of the groove passes directly next to conduits (4) and (2).

In this method of implementation, the joint that will be established in the groove (52) is of the kind illustrated in FIG. 7.

As depicted in this figure, the joint (6) takes on a complementary shape to that of the groove (52), in addition to which it is made of a single piece (for example by molding an elastically bendable plastic material) with valve (21) and valve (41) (intended to be positioned in the intake conduit (2) and the security conduit (4), respectively, positioned directly next to the groove (52)).

As for valve (31) (described previously in reference to FIG. 8) it is independent of the joint (6).

Moreover, the lid (7) accommodates a volume available for the circulation of air, from which a conduit (71) extends, which can either lead directly to the open air or be dedicated to a conduit through which remote air is taken in.

The air flows that might circulate in the piece (5) are those described in reference to FIGS. 2 to 5.

Advantageously, a device such as the one that was just described can be adapted to enclosures such as the enclosures of:
a rear axle assembly differential of a vehicle;
a vehicle transmission;
a fuel reservoir of a vehicle.

1. Device for circulating air between the interior and the exterior of an enclosure (1) intended to contain air and a liquid, the enclosure (1) being intended for installation in a vehicle, characterized in that it consists of at least an air intake conduit (2) and an air release conduit (3) connecting the interior and the exterior of said enclosure (1), in which the air intake conduit (2) is dedicated to the intake of air under normal conditions of pressure difference between the interior and the exterior of said enclosure (1), and the air release conduit (3) is dedicated to the release of air under normal conditions of pressure difference between the interior and the exterior of said enclosure.

2. Device described in claim 1, characterized in that it includes a means (32) of retaining said liquid inside the enclosure (1).

3. Device described in claim 2, characterized in that said means of retention (32) is installed on said air release conduit (3).

4. Device described in claim 3, characterized in that said means of retention (32) include a first membrane that obstructs said air release conduit from the interior of said enclosure (1).

5. Device described in claim 1, characterized in that it includes a means (22) of filtering the air taken into said enclosure (1).

6. Device described in claim 5, characterized in that said means of filtration (22) includes a second membrane obstructing at least said air intake conduit (2), on the exterior side of said enclosure (1).

7. Device described in claim 1, characterized in that it includes a safety conduit (4) that is independent of said air release (3) and air intake (2) conduits, to compensate for an excessive difference in pressure between the interior and the exterior of said enclosure (1).

8. Device described in claim 7, characterized in that said safety conduit (4) has at least one bi-directional valve (41) with wings (411, 412) that can move under the effect of a predetermined pressure difference between the interior and the exterior of the enclosure (1).

9. Device described in claim 1, characterized in that said air intake conduit (2) and/or said air release conduit (3) have at least one calibrated unidirectional valve (21, 31).

10. Device described in claim 8, characterized in that said air intake (2) and air release (3) conduits are positioned in a single piece (5) that is intended to be joined to said enclosure (1).

11. Device described in claim 10, characterized in that it includes a joint (6) to form an airtight seal between said single piece (5) and said enclosure (1), said single piece (5) having a groove (52) to accommodate said joint (6).

12. Device described in claim 11, characterized in that at least one of said conduits (2) is positioned next to said groove (52), said joint (6) forming a one-piece ensemble with said valve (21) of said conduit (2).

13. Device described in claim 10, characterized in that said safety conduit (4) is also positioned in said piece (5).

14. Device described in claim 13, characterized in that said safety conduit (4) is positioned next to said groove (52) said joint (6) forming a one-piece ensemble with said valve (41).

15. Device described in claim 1, characterized in that said enclosure (1) is an enclosure for the front or real axle assembly differential of a vehicle.

16. Device described in claim 1, characterized in that said enclosure (1) is the enclosure for a vehicle transmission.

17. Device described in claim 1, characterized in that said enclosure (1) is the enclosure for a fuel or lubricant reservoir.
